(19) United States
(12) Patent Application Publication
(10) Pub. No.: US 2004/0184607 A1
(43) Pub. Date: Sep. 23, 2004

(54) CRYPTO-SYSTEM WITH AN INVERSE KEY EVALUATION CIRCUIT

(76) Inventors: Chih-Pen Chang, Taipei City (TW); Ming-Shiang Lai, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/605,540

(22) Filed: Oct. 7, 2003

(30) Foreign Application Priority Data
Mar. 14, 2003 (TW) 092105706

(51) Int. Cl. H04L 9/00

(52) U.S. Cl. 380/45

(57) ABSTRACT

An inverse key evaluation circuit for inversely generating a plurality of pre-keys in sequence according to an original key, and a crypto-system containing the inverse key evaluation circuit for decrypting a ciphered text into a plain text according to the plurality of pre-keys. The inverse key evaluation circuit includes a key-receiving module and an inverse key evaluation module. The key-receiving module includes a register for temporally receiving and storing the original key, which will be processed by the inverse key evaluation module to generate the plurality of pre-keys of the original key. The key stored in the register will then be replaced by the newly generated pre-key in sequence. The crypto-system includes a key-generating module that contains the inverse key evaluation circuit, an encryption module, and a decryption module.

### BACKGROUND OF INVENTION

1. Field of the Invention

The invention relates to a crypto-system, and more particularly, to a crypto-systemwith an inverse key evaluation circuit and a related decryption method for reducing use of random access memory (RAM).

2. Description of the Prior Art

A major difference between a wireless LAN and a normal fixed LAN is that the wireless LAN transmits data by radio, but the later transmits data by cables or optical fibers. Since radio can be intercepted more easily, the security of data is a major focus of wireless LAN. For example, IEEE provides 802.11i as a standard to enhance the data security of wireless LAN. In fact, the concept of using cryptography to provide networks with better security protection can be applied to each kind of network transmission.

Among those, the data encryption standard (DES) using a 56-bit key is the most famous and widely used. However, as electronic technology develops and processing speeds of computers improve, concepts and experiments involving the design of special hardware or the organization of many computers for solving the data encryption standard have been increasing of late. This leads to lower the security of systems that use the DES as an algorithmic mechanism.

In October 2000, NIST declared that the Rijndael algorithm was chosen for use in a new standard—Advanced Encryption Standard (AES), which became a data encryption standard of the United States in 2001 and aimed to gradually replace previous data encryption standards. The Rijndael algorithm and the AES based thereon are shown in the literature of “Rijndael, the advanced encryption standard” disclosed by J. Daemen and V. Rijmen in Dr. Dobb's Journal 2001.

The AES is a block cipher/decipher algorithm. It plays a central role for realizing the network security of the IEEE 802.11i standard. All security modes are extended applications based on the AES. In current cryptography technology, which is grouped according to key types, the AES is regarded as a symmetric encryption system because its encryption operations and decryption operations are based on the same key.

Due to this property, the security of a symmetric encryption system depends on two things. First, the enciphering algorithm must be powerful enough to make it impossible in practice to obtain deciphered information only according to the enciphered texts. Secondly, the security of the encryption is dependent on the security of the keys but not on the security of the encryption/decryption algorithm. As a result, the secret of the keys becomes more important. In U.S. Pat. No. 5,539,827, “Device and method for data encryption” disclosed by Liu etc., a user could utilize a key to determine the encryption/decryption intensity and increase the secret of the encryption process. In U.S. Pat. No. 6,192,129, “Method and apparatus for advanced byte-oriented symmetric key block cipher with variable length key and block” and U.S. Pat. No. 6,243,470, “Method and apparatus for advanced symmetric key block cipher with variable length key and block” disclosed by Coppersmith etc., encryption/decryption algorithms similar to the AES are also disclosed, and keys with variable lengths determined by users are also provided to increase the complexity of the encryption process. The plain text in the AES is fixed to 128-bits and the key is also 128-bits.

Please refer to FIG. 1, which is a functional block diagram of a conventional crypto-system 10 qualified under the AES. As shown in FIG. 1, each round in the AES is composed of four reversible converting layers which are: a key addition layer 12, a byte substitution layer 14, a shift row layer 16, and a mix column layer 18. A controlling module 20 is used to control the evaluation in each round.

The round evaluations through the four layers will be repeated 10 times in total, wherein different keys are used in each round evaluation. These different keys are generated by a key scheduling module 22 for increasing the disorder degree of the encoded data. Thus, an encryption process qualified under the AES with 128-bit keys can be performed as shown in FIG. 1. First, a 128-bit key, which is a first key or so-called original key, is expanded to generate another 10 128-bit keys. Each newly generated key is used in a different round evaluation to perform an encryption/decryption operation for a document. As a result, the document will experience encryption/decryption operations 11 times according to eleven 128-bit keys, one original key and 10 keys derived from the original.

In the implementation of the AES, the key scheduling module performs an important algorithm. As previously mentioned, the purpose of the key scheduling module is providing a new key according to the key given by the upper layer, in which the new key is totally different from the previous key. In other words, a plurality of related but totally different keys are generated to ensure the encryption method based on the keys can make enciphered data extremely different from the original data.

Please refer to FIG. 1. The AES structure further comprises a read only memory (ROM) 24 for storing algorithms corresponding to the plurality of encryption/decryption operations and related application programs. Furthermore, the prior art technology has a random access memory (RAM) 26 for storing temporary operating variables i.e. the generated keys, from which a proper key is picked in each round evaluation.

In evaluating the performance of an algorithm, bigger programs and tables, which occupy a larger area of the ROM 24, or more temporary operating variables such as the generated keys, which occupy a larger area of the RAM 26, usually improve the operation speed of encryption/decryption. However, increasing the occupied area of memory increases the cost. In addition, the more generated keys stored in the RAM 26, the bigger the delay in the data access time of the receiver, which leads to lower system performance. As mentioned above, the RAM 26 must store eleven 128-bit keys comprising the original key and its 10 derivatives, so a certain amount of space and cost are necessary.

### SUMMARY OF INVENTION

It is therefore a primary objective of the claimed invention to provide a crypto-system with an inverse key evaluation circuit and a related method to reduce the use of memories to solve the aforementioned problems.

According to the claimed invention, an inverse key evaluation circuit and a related method applied to a crypto-system are provided to reduce the use of the RAM and also avoid the time delay associated with the receiver accessing the data in the RAM. The crypto-system in the claimed invention performs the encryption operation and the decryption operation with two different modules. The encryption operation uses a ROM-based method to increase the operating speed. The decryption operation uses an inverse key evaluation circuit and a related encryption method. Both the encryption and decryption operations use the same key generating module to keep the hardware qualified under the AES. By doing so, the circuit operating speed is not decreased, and no additional circuits are required.

The claimed invention provides an inverse key evaluation circuit applied to a crypto-system comprising a key receiving module comprising an N-bit register, which comprises m groups of registers for receiving an N-bit key. The N-bit key comprises m groups of keys, which are stored in the m group of registers respectively. Both N and m are power-of-two integers larger than two.

The inverse key evaluation circuit further comprises an inverse key evaluation module comprising an m XOR logic gates and a digital data processing module for inverse evaluation to sequentially generate a plurality of pre-keys according to the keys received by the key-receiving module. The keys stored in the N-bit register are sequentiallyreplaced by the pre-keys, which are obtained by utilizing the inverse key evaluation module to process the keys one at a time.

The claimed invention also provides a decryption method to decrypt an N-bit enciphered text string into a corresponding N-bit plain text string wherein N is a power-of-two integer larger than two. The decryption method comprises following steps: providing a key and the enciphered text string, using an inverse key evaluation module to generate a plurality of pre-keys according to the key, and utilizing the key and the sequentially-generated pre-keys to perform a plurality of corresponding decryption operations to decrypt the enciphered text string into the plain text string.

Furthermore, the claimed invention also provides a crypto-system for performing a plurality of encryption operations and decryption operations. The crypto-system comprises a key generating module for providing a plurality of keys. The key generating module comprises a forward key evaluating circuit and an inverse key evaluating circuit. The forward key generates a plurality of post-keys according to the original key. The inverse key evaluating circuit uses the last post-key to generate a plurality of pre-keys the last being the original key.

The crypto-system further comprises an encryption module and a decryption module both electrically connected to the key generating module. The encryption module is used for performing a plurality of encryption operations that encrypt a plain text string into a corresponding enciphered text string according to the original key and the sequential post-keys generated by the forward key evaluation circuit. The decryption module is used for performing a plurality of decryption operations that decrypt an enciphered text string into a corresponding plain text string according to the original key and the sequential pre-keys generated by the inverse key evaluation circuit.

It is an advantage of the claimed invention that the crypto-system and the related method can reduce the use of the memories to solve the aforementioned problems.

These and other objectives of the present invention will no doubt become obvious to those of ordinary skill in the art after reading the following detailed description of the preferred embodiment, which is illustrated in the various Figures and drawings.

### BRIEF DESCRIPTION OF DRAWINGS

FIG. 1 is a functional block diagram of a crypto-system qualified under the advance encryption standard (AES) in the prior art.

FIG. 2 is a functional block diagram of an inverse key evaluation circuit according to an embodiment of the present invention.

FIG. 3 is a functional block diagram of inverse key evaluation circuit according to the embodiment of FIG. 2.

FIG. 4 is a flow chart of a decryption method according to the present invention.

FIG. 5 is a functional block diagram of a crypto-system of the present invention.

FIG. 6 is a functional block diagram of an inverse key evaluation circuit according to an embodiment of FIG. 5.

### DETAILED DESCRIPTION

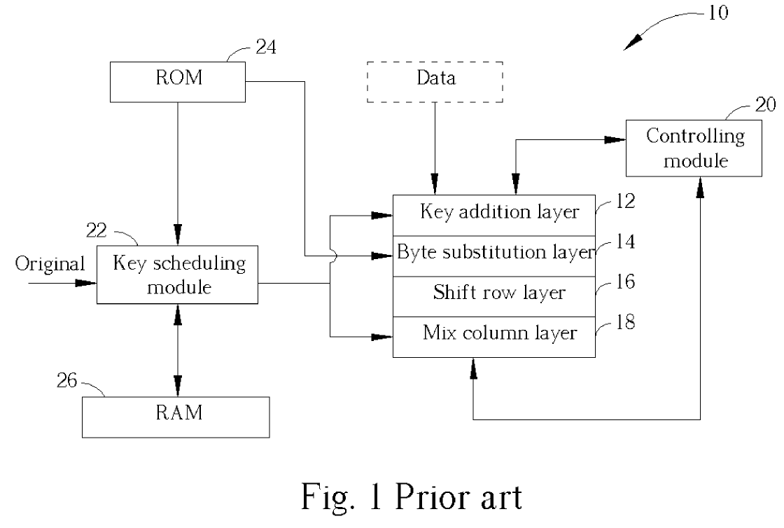

The technological feature of the present invention is based on the AES, and the purpose of the present invention is to implement the AES with hardware offering the best performance. In the present invention, an inverse key evaluation circuit is first disclosed for evaluating a plurality of related pre-keys of a key so that the use of the RAM can be reduced. By using some technological features in the prior art shown in FIG. 1 of a crypto-system, during encryption using an original key, 10 groups of post-keys are calculated. In the decryption, the order of the needed keys is opposite to that of encryption. In other words, if the sequence order of evaluated keys in the encryption is key 0 (the original key), key 1, key 2, key 3, . . . and key 10, the sequence order of needed keys in decryption is key 10, key 9, key 8, . . . and key 0 (the original key).

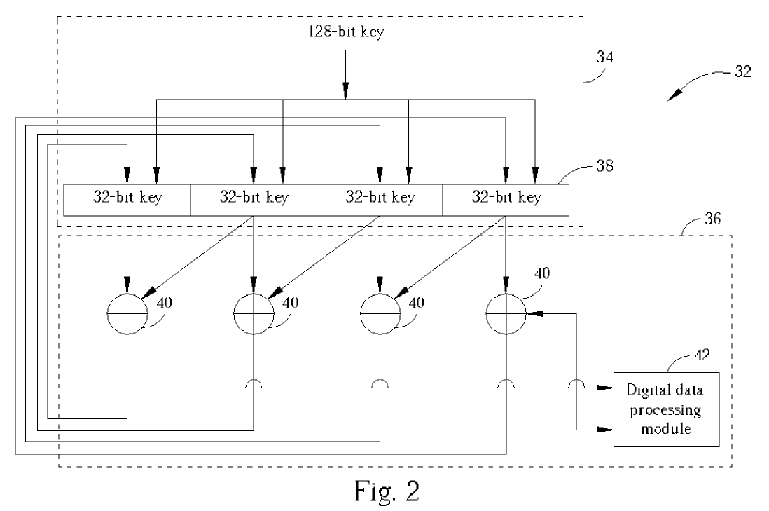

Please refer to FIG. 2, which is a functional block diagram of an inverse key evaluation circuit 32 according to an embodiment of the present invention. The inverse key evaluation circuit 32 comprises a key receiving module 34 and an inverse key evaluation module 36. The key receiving module 34 comprises an N-bit register 38, which comprises m groups of registers for receiving a N-bit key. The N-bit key can be divided into m groups of keys. The m groups of keys are stored in the m groups of registers respectively. N and m are both power-of-two integers larger than two.

In the present embodiment, N is 128 due to the rule of the AES and m is set to 4 due to the algorithm. However, the value of N and M can be adjusted in advance according to the situation in practice. The inverse key evaluation module 36 comprises m XOR logic gates 40. In other words, the number of the XOR logic gates corresponds to the number of m keys in a group with each XOR logic gate performing an XOR operation on two of the keys from the m groups of keys. The inverse key evaluation module 36 further comprises a digital data processing module 42 electrically connected to the m XOR logic gates 40 for inversely evaluating the keys received by the key receiving module 34 to generate a corresponding plurality of pre-keys.

Similar to the aforementioned conventional technology, the process repeats for 10 times to generate 10 pre-keys in sequence. If the 128-bit key is called key 10, the pre-keys are key 9, key 8, . . . and key 0 in sequence. Notice that the keys stored in the N-bit register 38 of the key receiving module 34 are replaced sequentially by the pre-keys obtained by utilizing the inverse key evaluation module 36, which processes the keys one at a time. In other words, according to the feature of the present invention, only one N-bit register 38 a 128-bit register—is required for storing the generated keys wherein the register can be realized by a RAM in practice. Compared with the prior art technology, this kind of inverse key evaluation mechanism is not available, meaning that the RAM must store all the keys comprising the original key and the keys generated from the original key for a total of eleven 128-bit keys. As a result, the inverse key evaluation circuit can effectively reduce the space and cost of the RAM circuit.

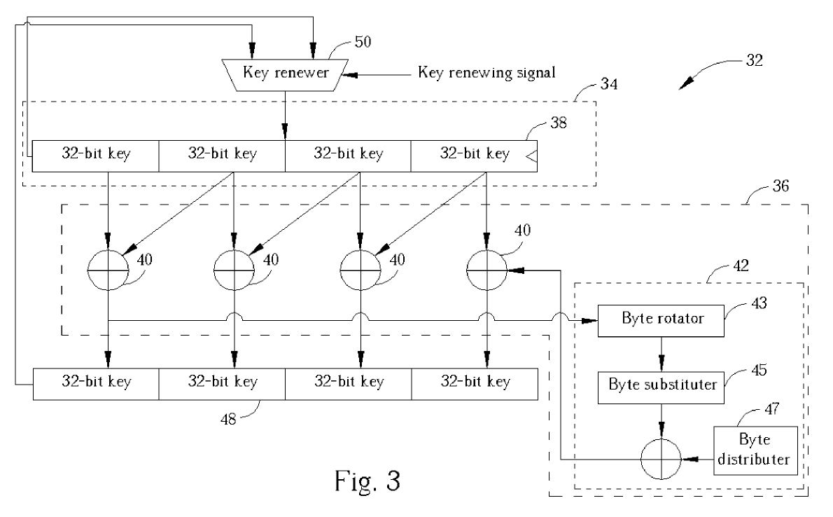

Please refer to FIG. 3, which is a detailed functional block diagram of the inverse key evaluation circuit 32 in FIG. 2. The digital data processing module 42, which is electrically connected to four XOR gates 40, comprises a byte rotator 43, a byte substituter 45, and a byte distributor 47. The byte rotator 43 is used to reverse the order of the bytes in the input key. The byte substituter 45 is electrically connected to the byte rotator 43 for replacing a plurality of bytes in the key with a plurality of predetermined bytes. The byte distributor 47 generates a distribution value according to a predetermined distribution table and performs XOR operations with the plurality of bytes in the key.

After being processed once by the four XOR logic gates 40 and the digital data processing module 42 of the inverse key evaluation circuit 32, the newly obtained pre-key is stored in a register 48 in the present embodiment. The register 48, which is electrically connected to the inverse key evaluation module 36, works in the same manner as the 128-bit register 38 in the key receiving module 34 shown in FIG. 2 and FIG. 3. The key stored in the register 48 is replaced each time by each newly obtained pre-key, which is the result of an inverse evaluation of the key. As a result, the register 48 only needs 128 bits for storing the key.

In the present embodiment of the present invention, two registers, which are 128-bit register 38 in the key receiving module 34 and the additional register 48, are employed. A pre-key obtained after an inverse key evaluation is first stored in the additionally employed register 48. A key renewer is required to then copy pre-key into the 128-bit register 38. The key renewer 50, which is electrically connected to the 128-bit register 38 in the key receiving module 34 and the additional register 48, does so in response to a key renewing signal.

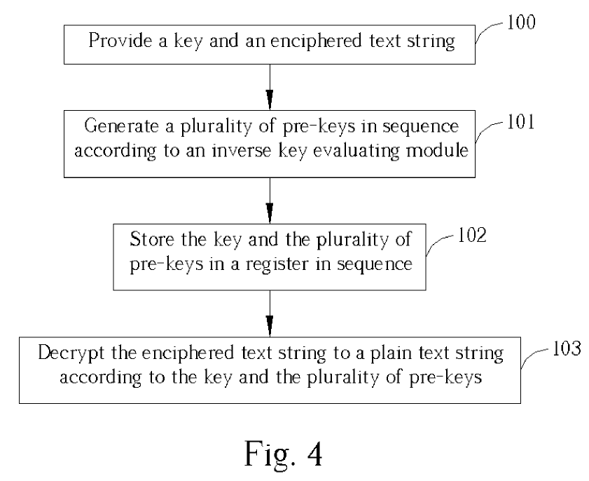

Since the theory of the inverse key evaluation circuit 32 in the present embodiment is based on the AES, the inverse key evaluation circuit 32 in the present embodiment can be applied to a wireless LAN, specifically to a decryption related method and apparatus. Please refer to FIG. 4, which is a flow chart of a decryption method according to FIG. 2 and FIG. 3. The decryption method of the present invention is used to decrypt an N-bit enciphered text string into a corresponding N-bit plain text string. N is a power-of-two integer larger than two. According to the embodiments shown in FIG. 2 and FIG. 3, N is 128, meaning the enciphered text string and the plain text string are both 128-bit text strings. According to the AES, the key is also set to 128-bit. The decryption method comprising steps in following:

Step 100: Providing a key and an enciphered text string;

Step 101: Using the inverse key evaluation module 36 to generate a plurality of pre-keys from the key;

Step 102: Using a key register 48 to store the key and the plurality of pre-keys sequentially generated from the key;

Step 103: Using the key and the plurality of pre-keys, sequentially generated from the key, to perform a plurality of decryption operations to decrypt the enciphered text string to the plain text string.

In step 102, the key stored in the register 38 is continually replaced by the next sequential pre-key. The pre-keys are obtained one at a time by utilizing the inverse key evaluation module 36 to process the key stored in register 38. Thus, the register 48 only needs 128 bits because it only needs to store one key at a time. It is much different from the conventional RAM, which needs much space to store all 128-bit keys 11 in total.

All the aforementioned embodiments and methods are based on the feature of the inverse key evaluation circuit 32 in the present invention, which is using a last key to generate a plurality of pre-keys thereof. As mentioned above, during decryption with a 128-bit key, which is called a last key, 10 groups of pre-keys are generated by the inverse key evaluation circuit 32. In encryption, the order of the needed keys is opposite to that of decryption i.e. a first key also known as an original key is used to generate 10 post keys with the last post key being the same as the last key used in decryption. Thus, not all keys are required to be stored since all the pre-keys can be generated if the last key is stored. This is the most important function of the inverse key evaluation circuit 32.

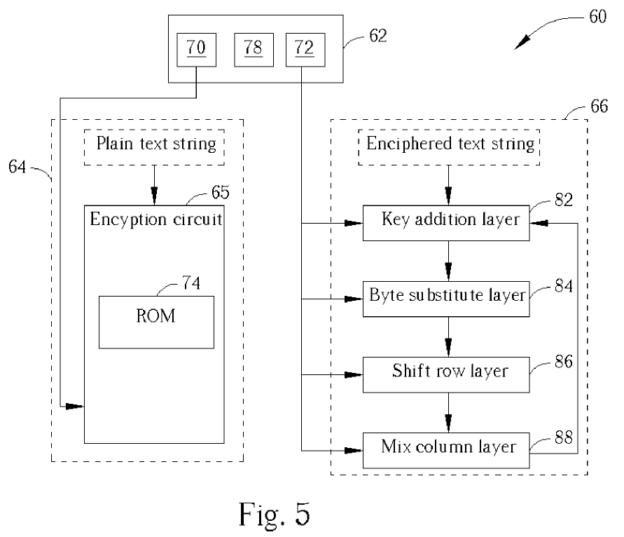

A functional block diagram of the crypto-system 60 in the present invention with the inverse key evaluation circuit 32 is shown in FIG. 5. The crypto-system 60 comprises a key generating module 62, an encryption module 64, and a decryption module 66. The key generating module 62 can be used to evaluate or generate a plurality of keys, which are required in encryption and decryption. It also determines if the encryption module 64 or the decryption module 66 is working and transmits corresponding keys to the proper module.

The key generating module 62 further comprises a forward key evaluation circuit 70, an inverse key evaluation module 72, which corresponds to the inverse key evaluation circuit 32 shown in FIG. 2 and FIG. 3, and a register 78. The forward key evaluation circuit 70 can generate a plurality of post-keys of an original key according to the original key until generating the last key. The inverse key evaluation circuit 72 can generate a plurality of pre-keys of the last post key according to the last post-key until generating the original key.

According to the AES, suppose that the order of evaluation of the forward key evaluation circuit 70 is key 0 (the original key), key 1, key 2, key 3, . . . and key 10. Then the order of the evaluation of the inverse key evaluation circuit 72 is key 10, key 9, key 8, . . . and key 0 (the original key). In addition, the register 78 in the key generating module 62 is used to store the original key (key 0). When the encryption module 64 wants to encrypt a plain text string to an enciphered text string, the forward key evaluation circuit 70 provides the original key (key 0) stored therein and the plurality of post-keys generated according to the original key to the encryption module 64 in sequence. During this time, the register 78 stores the last key (key 10) for provision to the decryption module 66 to decrypt the enciphered text string.

The reason why the register 78 is used to store the last key (key 10) is to save time. By saving the last key (key 10), additional time does not need to be spent by the forward key evaluation circuit 70 to evaluate the last key (key 10) whenever encrypted data is received. In other words, when the last key (key 10) is evaluated in encryption, it is stored in register 78. The last key can then be directly provided to the inverse key evaluation circuit 72 during decryption for processing instead of waiting for the forward key evaluation circuit 70 to evaluate the last key from the original key.

The encryption module 64 comprises an encryption circuit 65 electrically connected to the key generating module 62 for sequentially performing a plurality of corresponding encryption operations according to the original key (key 0) and the sequentially generated post-keys (key 1-10), which are provided by the forward key evaluation circuit, to encrypt a plain text string into a corresponding enciphered text string. These encryption operations are similar to the round evaluation shown in FIG. 1. However, in this embodiment, the encryption module 64 with the encryption circuit 65 is an improved ROM-based encryption module 64 comprising a plurality of ROMs 74 for storing the algorithm corresponding to the plurality of the encryption operations and the related application programs. Thus, the functions of each of the four reversible transfer layers can be replaced by the ROMs 74 which can operate faster with the programs and tables stored therein.

The decryption module 66 is also electrically connected to the key generating module 62 for sequentially performing a plurality of corresponding decryption operations according to the last post-key (key 10) and the sequentially generated pre-keys (key 9 to 0), which are provided by the inverse key evaluation circuit 72, to decrypt an enciphered text string into a corresponding plain text string. These decryption operations follow the structure of using a plurality of round operations for decryption, which is described in FIG. 1. It means that a key addition layer 82, a byte substitute layer 84, a row shift layer 86, and a column mix layer 88 are used for performing the corresponding decryption operations to decrypt an enciphered text string into the original plain text string.

Note that the forward key evaluation circuit 70 of the key generating module 62 in the present embodiment is similar to the aforementioned key scheduling module 22 in the prior art. Please also note that the register 78 in the present embodiment only needs to store the original key (key 0) and the last post-key (key 10). One could also have the register 78 only store the original key (key 0) if the inverse key evaluation circuit 72 further comprises an additional register for storing the last post-key (key 10). No matter which kind of circuit layout is set, the used memory can be reduced effectively in comparison with the prior art technology, which needs to store all keys (key 0 to key 10).

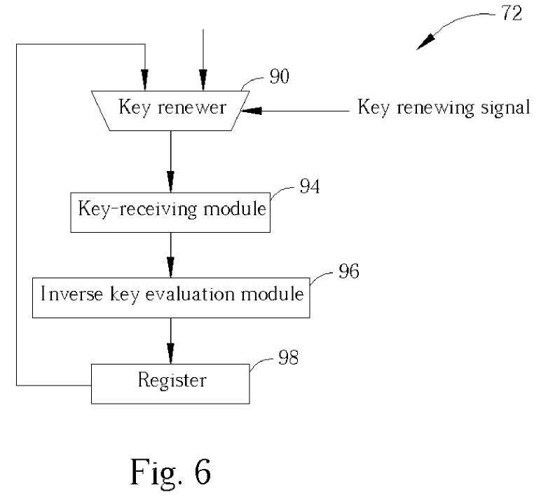

Please refer to FIG. 6, which shows an embodiment of the inverse key evaluation circuit 72 in FIG. 5, similar to the embodiment shown in FIG. 2. It comprises a key renewer 90, a key receiving module 94, an inverse key evaluation module 96, and a register 98. The key receiving module is used for receiving and storing the last key (key 10). The inverse key evaluation circuit 96 is used to generate a plurality of pre-keys (key 9 to key 0) according to the last key (key 10) received by the key receiving module 94 until generating the original key (key 0). The register 98 is electrically connected to the inverse key evaluation module 96 for storing a pre-key, which is obtained through an inverse evaluation. In the same manner as mentioned earlier, the key stored in the register 98 is continually replaced by a newly generated pre-key, which is obtained from the inverse evaluation of the key.

When the crypto-system 60 in FIG. 5 performs a system reset or replaces the old original key (key 0) with a new original key, an initialization process is performed to evaluate the last key (key 10) from the new original key (key 0) by the forward key evaluation circuit 70 in FIG. 5. At that time, the key renewer 50 receives a key renewing signal to update the new last key (key 10) into the key receiving module 94. The key renewer 50 can then rewrite the pre-key, which is obtained through one inverse evaluation, from the register 98 to the key receiving module 94.

The crypto-system in the present invention performs the encryption and the decryption with two different modules. The encryption is performed in a ROM-based method to increase the calculation speed, and the decryption uses an inverse key evaluation circuit and its related algorithm to inversely evaluate the pre-keys sequentially. Only a small amount of memory is required for storing the initial key and the last key. As a result, the usage of the RAM can be reduced, so that the accessing data delay of the receiver can be avoided. Furthermore, the encryption and decryption in the crypto-system of the present invention both use a common key generating module. As a result, the operation speed can remain fast, and no additional circuits are required to realize the hardware qualifications of the AES.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An inverse key evaluation circuit for a crypto-system, the inverse key evaluation circuit comprising:
a key-receiving module comprising an N-bit register which comprises m groups of registers for receiving an N-bit key which comprises m groups of keys, the m groups of keys stored in the m groups of registers respectively, both of N and m being power-of-two integers larger than two; and
an inverse key evaluation module comprising m XOR logic gates and a digital data processing module for inversely evaluating to generate a plurality of pre-keys in sequence according to the keys received by the key-receiving module;
wherein the keys stored in the N-bit register are replaced in sequence by the pre-keys which are obtained by utilizing the inverse key evaluation module to process the keys once.

2. The inverse key evaluation circuit of claim 1 wherein the value of N is 128 and the value of m is 4, the key received by the key-receiving module at first is inverse evaluated ten times to generate ten pre-keys in order.

3. The inverse key evaluation circuit of claim 1 wherein the digital data processing module in the inverse key evaluation module is electrically connected to the m XOR logic gates, the digital data processing module comprising:
a byte rotator for inverting the order of a plurality of bytes in the N-bit key;
a byte substituter electrically connected to the byte rotator for substituting a plurality of predetermined bytes for the bytes in the N-bit key; and
a byte disturber for generating a disturbing value according to a predetermined disturbing table and utilizing the disturbing value to perform an XOR operation with the bytes in the N-bit key.

4. The inverse key evaluation circuit of claim 1 wherein the inverse key evaluation circuit further comprises a register electrically connected to the inverse key evaluation module for storing a key obtained through one inverse key evaluation, wherein the key storing in the register is replaced by a pre-key generated from the key through one inverse key evaluation.

5. The inverse key evaluation circuit of claim 1 wherein the crypto-system is qualified to an advanced encryption standard (AES).

6. The inverse key evaluation circuit of claim 5 wherein the crypto-system is applied to a wireless LAN.

7. A decrypting method for decrypting an N-bit enciphered text string to a corresponded N-bit plain text string, N being a power-of-two integer larger than two, the decrypting method comprising:
providing a key and the enciphered text string;
utilizing an inverse key evaluation module to sequentially generate a plurality of pre-keys of the key; and
using the key and the pre-keys generated from the key to perform a plurality of corresponding decryption operations for decrypting the enciphered text string to the plain text string.

8. The method of claim 7 wherein the method further comprises using a register to store the key and the pre-keys sequentiallygenerated from the key, the key stored in the register is sequentially replaced by a next pre-key which is obtained by utilizing the inverse key evaluation module to process the key once.

9. The method of claim 7 wherein the key is a N-bit key, in which N is equal to 128, and 10 pre-keys can be obtained in order from the key via the inverse key evaluation module.

10. The method of claim 9 wherein the inverse key evaluation module comprises m XOR logic gates and a digital data processing module to perform a plurality of inverse key evaluations according to the key and sequentially generate a plurality of pre-keys corresponding to the key, m being a power-of-two integer larger than two.

11. The method of claim 10 wherein the digital data processing module is electrically connected to the m XOR gates, the digital data processing module comprising:
a byte rotator for inverting the order of a plurality of bytes in the N-bit key;
a byte substituter electrically connected to the byte rotator for substituting a plurality of predetermined bytes for the bytes of the N-bit key; and
a byte disturber for generating a disturbing value according to a predetermined disturbing table and utilizing the disturbing value to perform an XOR operation with the bytes in the N-bit key.

12. The method of claim 7 wherein the method is qualified to an advance encryption standard (AES).

13. The method of claim 12 wherein the method is applied to a crypto-system in a wireless LAN.

14. A crypto-system for performing a plurality of encryption operations and a plurality of decryption operations, the crypto-system comprising:
a key-generating module for providing a plurality of keys, the key-generating module comprising:
a forward key evaluation circuit for generating a plurality of post-keys of an original key according to the original key until generating the last key;
an inverse key evaluation circuit for generating a plurality of pre-keys of the last post key according to the last post-key until generating the original key; and
at least one register for storing the original key and the last post-key;
an encryption module electrically connected to the key-generating module for sequentially performing a plurality of corresponding encryption operations according to the original key and the post-keys sequentially generated, which are provided by the forward key evaluation circuit, to encrypt a plain text string to a corresponding enciphered text string; and
a decryption module electrically connected to the key-generating module for sequentially performing a plurality of corresponding decryption operations according to the last post-key and the pre-keys sequentially generated, which are provided by the inverse key evaluation circuit, to decrypt an enciphered text string to a corresponding plain text string.

15. The crypto-system of claim 14 wherein the encryption module is a ROM-based encryption module comprising a plurality of ROMs for storing algorithms corresponding to the plurality of encryption operations and related application programs.

16. The crypto-system of claim 14 wherein the plain text string, the enciphered text string, and the plurality of keys are all 128-bit digital data.

17. The crypto-system of claim 14 wherein the inverse key evaluation circuit comprises:
a key-receiving module for receiving the last key;
an inverse key evaluation module comprising a plurality of XOR logic gates and a digital data processing module for generating a plurality of pre-keys according to the last key received by the key-receiving module until generating the original key; and
a register electrically connected to the inverse key evaluation module for storing a key obtained through one inverse key evaluation, the key stored in the register replaced by a pre-key obtained from the key through one inverse key evaluation.

18. The crypto-system of claim 14 wherein the crypto-system is qualified to an advance encryption standard (AES).

19. The crypto-system of claim 18 wherein the crypto-system is applied to a wireless LAN.
